(19) United States
(12) Patent Application Publication
(10) Pub. No.: US 2017/0112053 A1
(43) Pub. Date: Apr. 27, 2017

(54) Slope mower

(71) Applicant: Sergey Anatolyevich Babkin, Woodinville, WA (US)

(72) Inventor: Sergey Anatolyevich Babkin, Woodinville, WA (US)

(21) Appl. No.: 14/922,200

(22) Filed: Oct. 26, 2015

(51) Int. Cl. A01D 34/86; A01D 75/00; A01D 34/64

(52) U.S. Cl. CPC A01D 34/86; A01D 34/64; A01D 75/00

(57) ABSTRACT

A mowing apparatus created by connecting a powered walk-behind mower to the side of a small tractor using a rigid articulated frame. The length of the frame provides the extended reach into the slope, allowing the tractor to stay on the flat terrain while mowing the adjacent steep slopes. The connection between the tractor and the mower is rigid in the horizontal directions, allowing the fine control of the mower position during the tractor movement both forward and in reverse, straight and turning, and articulated in the vertical direction, allowing the mower to follow the shape of the slope and preventing the transmission of the excessive side forces to the tractor, avoiding the risk of the tractor overturning. The apparatus allows the tractor and the mower to be quickly disconnected and used separately for their original purposes.

### BACKGROUND OF THE INVENTION

The invention relates to the field of the grass cutters.

The invention provides a way of mowing the sloped areas with a small tractor (lawn or garden tractor).

There are other patents devoted to this and related purposes, including the following:
Side mower deck for a mower tractor, Eugene Murawski
   U.S. Pat. No. 7,305,811 B2
Slope mower with side frames, Dewey L. Hostetler et al.
   U.S. Pat. No. 4,869,054 A
Mower unit, Fuss William H
   U.S. Pat. No. 3,514,126 A
Mowing apparatus, Thomas J Dunn
   U.S. Pat. No. 3,135,079 A
Vehicle for use on flat or sloped surfaces, Norman R. Youngberg et al.
   U.S. Pat. No. 5,129,218 A
Slope mower, Norman R. Youngberg et al.
   U.S. Pat. No. 5,203,149 A
All terrain mower, Wendell L. LeBlanc
   U.S. Pat. No. 5,321,938 A
Tilting deck lawn mower, Harlan J. Bartel
   U.S. Pat. No. 6,874,308 B1
Gang mower, Erdman Leon Paul
   U.S. Pat. No. 3,608,284 A
Hitch for ganging lawn mowers, Richard H. Schmidt
   U.S. Pat. No. 4,063,748 A
Lawn mower towing device, J. Alexander Easley, Jr.
   U.S. Pat. No. 7,347,036 B1

However they attempt to simulate the large tractors and scale the solutions down to size. This does not work well because the small tractors simply do not have the weight to anchor the wide mowers and two-dimensionally-flexible powered articulated arms, nor the power to drive the extra mowers, nor the readily available power take-off systems. The result is that these solutions are expensive, difficult to use, and have a very limited reach. In other words, they are impractical.

The concept of connecting the extra self-powered mowers is also widely known. It is generally used to create a wider mowing path by towing the extra mowers with a small tractor. However it operates only in the close proximity to the tractor, and generally is intended for the use on the flat terrain. Even when the connections allow for a side mower to be inclined relatively to the tractor, such as in the U.S. Pat. No. 4,063,748, it is still mounted close to the tractor and allows only the very basic forward movement of the tractor with the limited inclination of the terrain.

### BRIEF SUMMARY OF THE INVENTION

Any owner of a property with steeply sloped sections or a landscaping professional who mows such properties with a small tractor also has a walk-behind mower to mow the sections where the tractor cannot be driven. The essence of this invention is to connect two pieces of equipment that the operator already owns and use the small tractor to propel the walk-behind lawn mover on the slope instead of driving it manually. This makes the job of mowing the sloped sections much easier and faster, and at minimal added cost.

The invention provides a rigid connection between the tractor and the remote mower placed to the side of the tractor, allowing the fine control of the mower position for both the forward and backward movement, with mowing even in the confined areas. It also places the mower at a farther distance from the tractor's side, thus providing a far reach into even the steep slopes (such as 45 degrees or more) where the tractor cannot be driven.

### BRIEF DESCRIPTION OF DRAWINGS

The attached drawings are:

FIG. 1. Overall view of the invention—top view.

FIG. 2. Bushing mounts between the fixed and articulated parts of the connection frame.

FIG. 3. Mounting of the fixed part of the connection frame to the tractor.

FIG. 4. Mounting brackets.

FIG. 5. Downhill mowing.

FIG. 6. Uphill mowing.

FIG. 7. Ditch mowing.

FIG. 8. The articulated part of the connection frame with a bend to accommodate the better location of the mount points on the mower.

FIG. 9. L-shaped frame.

FIG. 10. The reinforced tractor frame acting as the fixed part of the connection frame.

FIG. 11. The steering force diagrams.

FIG. 12. Connection frame located over the rear wheels of the tractor—top view.

FIG. 13. Connection frame located over the rear wheels of the tractor—side view.

FIG. 14. Quick-connect stubs.

FIG. 15. Connection frame adjustable by width.

FIG. 16. Offset quick-connect stubs.

FIG. 17. Invention with the dust shield.

FIG. 18. Mower with both the caster wheels and the main wheels.

FIG. 19. Mechanism of the automatic steering.

FIG. 20. Self-releasing safety clamp.

FIG. 21. Extended connection frame that prevents the mower from overturning.

FIG. 22. Safety tethering.

FIG. 23. Remotely releasable safety clamp.

The reference characters in the drawings are:
1. Tractor.
2. Walk-behind mower.
3. Fixed part of the connection frame.
4. Articulated part of the connection frame.
5. Bolt.
6. Bushing.
7. Bushing end-cap.
8. Mounting bracket.
9. Tractor frame.
10. Pin.
11. Pin.
12. Reinforced tractor frame.
13. Connector stub.
14. Pin.
15. Pin.
16. Adjustment receptacle tube.
17. Adjustment bar.
18. Offset connector stub.
19. Dust shield.
20. Connection frame mount of the mower.
21. Mower main wheels.
22. Mower caster wheels.
23. Pivot point.
24. Steering parallelogram control rod.
25. Safety clamp body.
26. Mower handle.
27. Safety clamp cam.
28. Safety clamp cam lever.
29. Safety clamp cam weight.
30. Mower safety lever.
31. Safety tether.
32. Safety tether spool.
33. Remotely releasable clamp.
34. Clamp control cable.
35. Control cable spool.

### DETAILED DESCRIPTION OF THE INVENTION

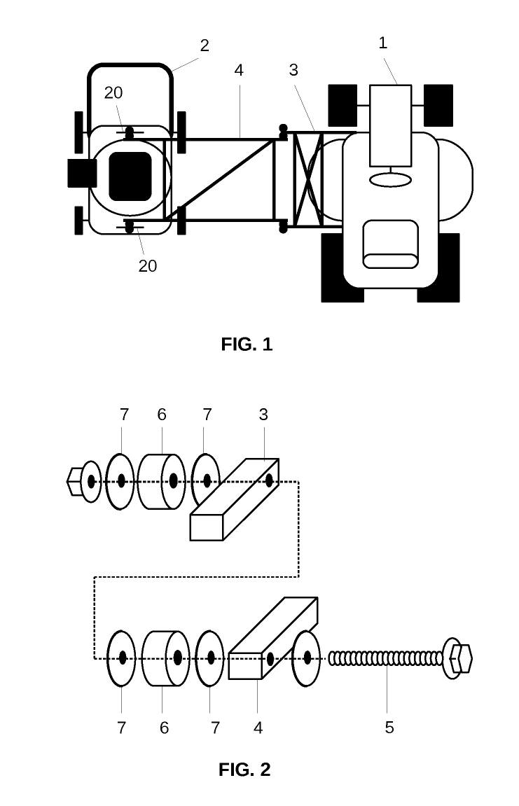

As shown in FIG. 1 (the top view) the connection between the tractor (1) and the walk-behind mower (2) is done by the connection frame that consists of the fixed part (3) and articulated part (4). The fixed part serves for mounting onto the tractor frame, provides the rigidity to offload the forces from the tractor's frame, and allows for the clearance from the tractor parts and from the mower deck mounted on the tractor. Removing the mower deck is a relatively lengthy operation, and thus the ability to mount and dismount the connection frame without the need to remove the tractor's own mower deck provides a major operational advantage.

The mower is shown turned in the reverse direction from the tractor, with the handle pointed forwards. It may be used in either direction, depending on the preference for the direction of the discharge (the discharge chute is usually located on the right side of the mower). When mowing the low, soft, regularly-mowed grass, the more beneficial direction of the discharge is away from the tractor, to reduce the amount of clippings and dust reaching the tractor operator. When moving the tall thick grass that has not been mowed for a long time, the more beneficial direction of the discharge is towards the tractor, to prevent the discharge chute from catching on the grass, and to ease the discharge and prevent the mower engine from stalling.

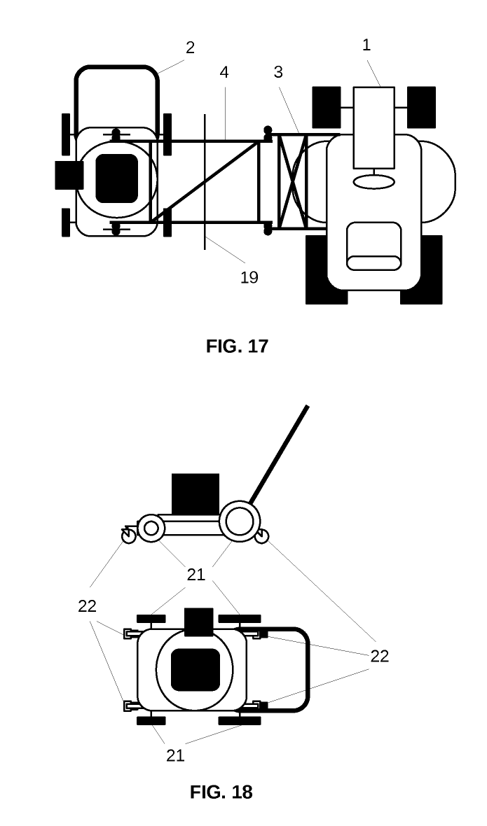

To reduce the amount of dust reaching the operator and to reduce the likelihood of injury from a hard object thrown by the mower blade, a dust shield may be placed on the articulated part of the frame. The FIG. 17 shows the dust shield (19). The top part of the shield can be made of a transparent polymer for the ease operation and the bottom part can be made flexible to clear the uneven terrain.

The articulated part of the frame (4) is mounted to the fixed part (3) and to the mounts (20) on the walk-behind mower (2), as shown in FIG. 2, by bolts (5) passing through the rubber or polymer bushings (6) with the metal end-caps (7) and through the connected parts. The arrangement is similar to the use of the bushings on the anti-sway bar end links in the automotive suspension, and serves a similar purpose of conducting the force along the bolts while providing the cushioning and allowing the limited movement of the parts in the direction across the bolts. The automotive bushings can be used as-is. The use of two bushings per connection provides cushioning for the forces during the movement in both forward and reverse directions. If the frame is made of compressible resilient material (such as polymer), the same effect can be achieved without the bushings. If the frame is made of a hard material, a particularly cheap implementation may still omit the bushings, with the disadvantage of increasing the slop in the frame and creating a possibility of binding.

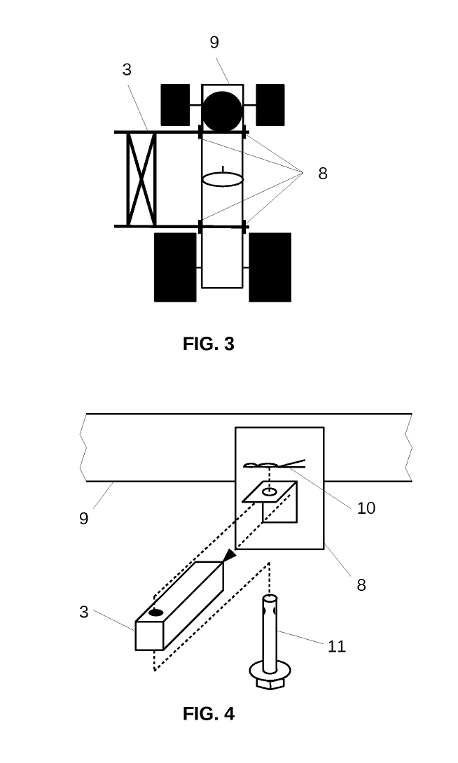

The fixed part of the connection frame (3) is mounted to the tractor frame (9) to keep it stable, with the mounting brackets (8), as shown in FIG. 3. The tractor is shown on FIG. 3 with the body elements removed for clarity. An example of a mounting bracket is shown up close in FIG. 4. Many varieties of the similar mounts can be devised. The purpose of the mounting brackets (8) is to fixate the connection frame (3) in the horizontal and lateral directions, while allowing it a small amount of movement in the vertical direction. The vertical movement allows both the connection frame and the tractor frame to have a small amount of independent flex which is important for the operation of the small tractors. In FIG. 4 the mounting bracket (8) is secured to the tractor frame (9) by bolts or rivets or welding or other means. The tube of the connection frame (3) is inserted through the hole in the mounting bracket (8). It is then tied to the mounting bracket by a pin (11) that is secured by another pin (10). The pins can be used on all four of the mounting brackets only on only two of them, on one side of the tractor. It is more convenient to use the pins on the side of the tractor where the connection frame tubes come out from the tractor (on FIG. 3 it is the right side of the tractor) where the access to them is easier. This also prevents the need for any welding or drilling and thus weakening of the connection frame tubes on the tractor side with the mower, where they require the most strength.

When mounting the connection frame to the tractor, the attention must be paid to avoid interference with the elements of the tractor's steering and transmission.

The mower may be mounted on either side of the tractor. However the inclined surface being moved often happens to be the berm on the side of the road. In this situation the safer direction is to have the tractor pointed opposite the traffic on the road, and thus in the countries that drive on the right side of the road the mower would be mounted on the left side of the tractor, as shown in FIG. 1.

The walk-behind mowers generally have a safety lever that stops the mower engine unless the lever is held in the operating position by the operator. After the mower is safely connected by the connection frame to the tractor, this safety lever becomes extraneous and needs to be defeated by clamping it in the operating position.

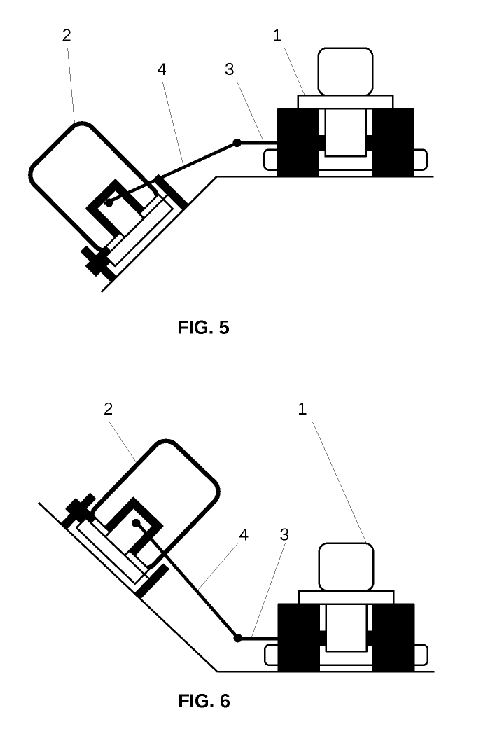

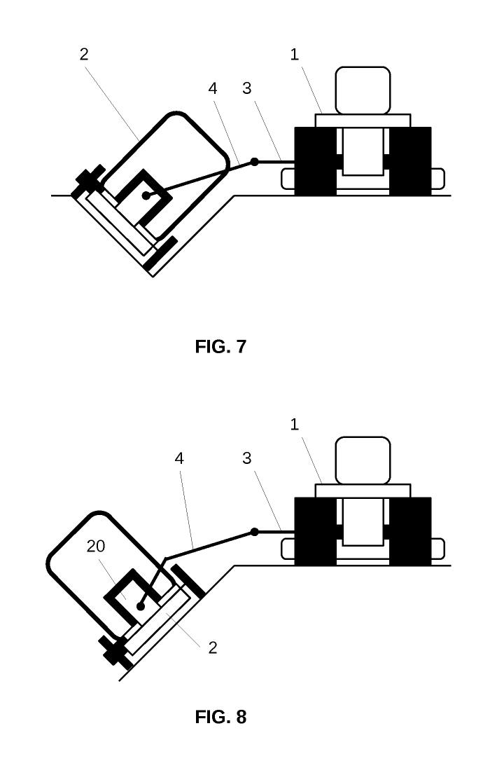

The mowing is conducted by driving the tractor (1) on a flat surface with the mower (2) driven by it on the adjacent inclined surface. The inclined surface may be directed downhill as shown in FIG. 5, uphill as shown in FIG. 6, or in a ditch as shown in FIG. 7. The position of mowing path on the inclined surface is determined by driving the tractor farther or closer to the slope. Such as, in FIG. 5 the mowing can start nearest to the top of the slope by driving the tractor farthest from the slope, then on each following pass the tractor would move to the left and thus move the mower deeper down the slope.

The location of the mounting points between the articulated part of the connection frame (4) and the mounts (20) on the mower (2) has been previously shown in a position that makes them easier to see, for the clarity of the figures. The lower location of the mounting points reduces the torque of the side forces from the tractor on the mower, thus reducing the possibility of overturning the mower. To use the lower mount points while still clearing the wheels and other components of the mower, the mower end of the articulated part of the connection frame may be bent as shown in FIG. 8.

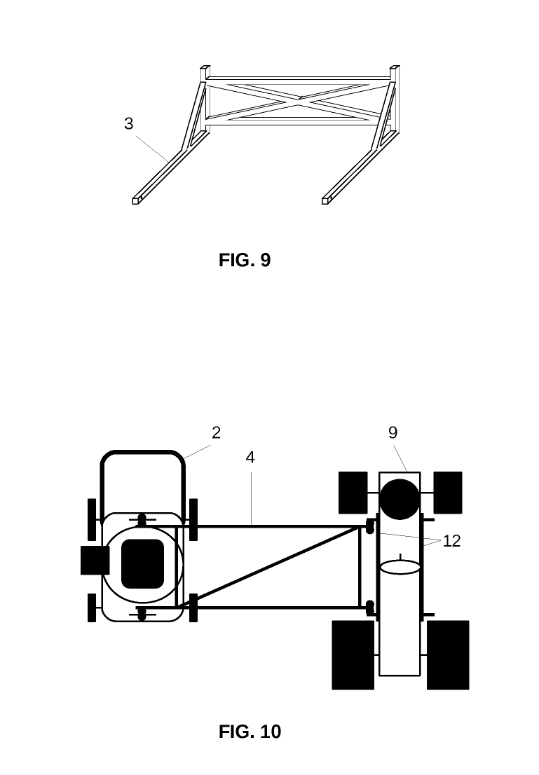

The fixed part of the connection frame (3) is the most stressed element, which requires the extra sturdiness and thus adds weight and cost. The stress on it can be reduced by shortening it. However it also needs to be long enough to clear the elements of the tractor (1) as such and the tractor's mowing deck, and to allow for the reinforcing X-brace. As can be seen from FIG. 5, the position of the joint between the fixed (3) and articulated (4) parts of the connection frames also determines the clearance of the articulated part (4) over the mower (2) and over the ground on the edge of the incline. The clearances can be provided by moving the end of the fixed part of the frame inboard to just clear the tractor's bodywork, and up. The articulated part of the frame can then be lengthened appropriately to compensate for the reach. Such an L-shaped fixed part of the frame is shown in FIG. 9 (rotated for a more convenient view).

Moreover, if the tractor is designed from the start with the use of the connection frame in mind, shaping the bodywork to avoid the interference with it, the fixed part of the connection frame may be eliminated altogether and replaced by the pickup points on the side of the suitably reinforced tractor frame (12), as shown in FIG. 10, where for clarity the tractor is shown with its frame (9) visible, without the bodywork and without its own mower deck.

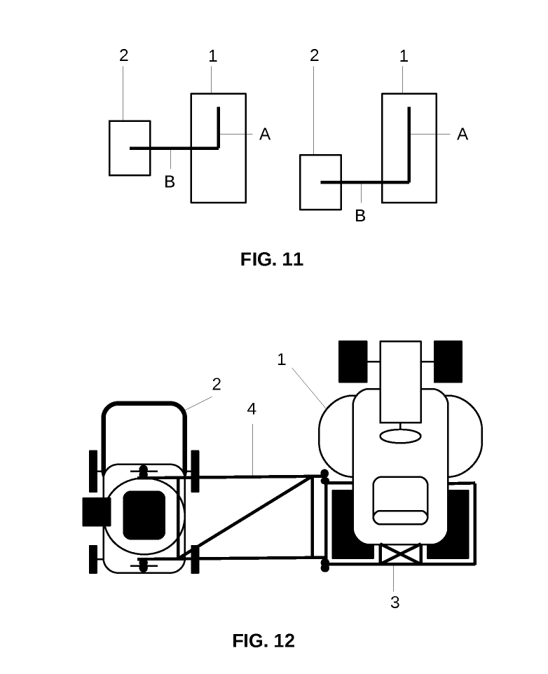

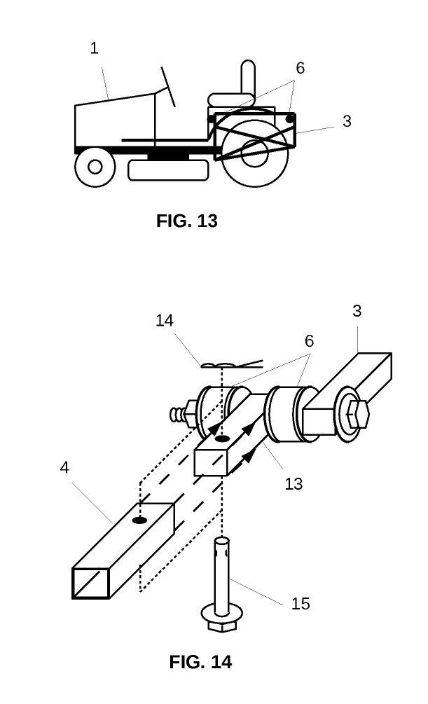

The maximal length of the connection frame is limited by the tractor's ability to steer. Increasing the length of the frame increases the leverage of the forces exerted by the weight and resistance of the mower. The leverage of the front wheels of the tractor on the mower is determined by the distance between the front wheels and the projection of the mower's center of gravity to the tractor, the relation of the distances A/B as shown in the diagram in FIG. 11. Placing the mower (2) farther back relative to the tractor (1) increases this relative leverage and allows to control the mower on a longer connection frame. The optimal location for the projection of the mower's center of gravity is slightly in front of the rear axle of the tractor, as show in FIG. 12. The fixed part of the connection frame (3) becomes a more complicated 3-dimensional space-frame to provide the necessary strength and rigidity, with the side view shown in FIG. 13, the connection points to the articulated part of the frame shown by the location of the bushings (6). It has to be bolted together in place and becomes not easily removable any more. However in this position it doesn't interfere much with the normal operation of the tractor nor with the tractor's own mower, and can be installed once and then left in place. If the tractor is designed from the start with the use of the connection frame in mind, the tractor's frame can be made longer and thus provide the extra structural rigidity and simplify the design and mounting of the connection frame, fitting it above the wheels within the dimensions of the tractor. The fixed part of the connection frame in this position may also be used as a foundation for the safety hoop.

Connecting the articulated part of the frame to its fixed part and to the mower by tightening the bolts is a relatively long procedure. It can be made faster and easier by bolting the connector stubs (13) and then quickly connecting the articulated part of the frame to these stubs. An example of such a connection is shown in FIG. 14. It performs the quick connection by sliding the stubs (13) into the tubes of the articulated frame (4) and fixating them with the pins (14, 15). Any other known method that connects them together securely and quickly can be used as well.

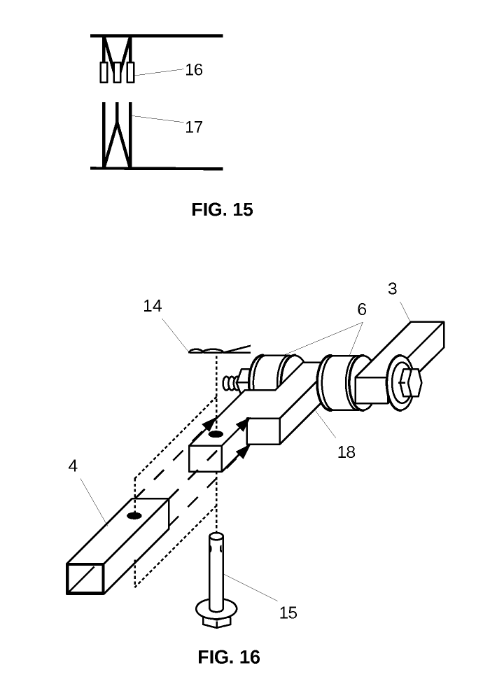

Different tractor models have different dimensions and clearances, and thus may require the frames of different width. To use a single universal connection frame model on various tractors, it must have an adjustable width. The fixed part of the frame can be made adjustable by designing it in two halves, as shown in FIG. 15, one with the receptacle tubes (16) and another one with the tubular bars (17) that get inserted into the receptacle tubes and then bolted together after adjustment for a particular width. This principle can be applied to all of the flat, L-shaped, and 3-dimensional frames. The frame needs to be adjusted once for a particular tractor and then bolted together in this position, and can be used afterwards without any further adjustment.

The articulated part of the frame can be either adjusted similarly, or made non-adjustable by itself. Instead the connection point between it and the fixed part (and also between it and the mount points on the mower) can be adjusted by adding the solid inserts in addition to the bushings, by changing the relation between the parts (the articulated part endpoints may be located to the inside of the fixed part endpoints as in FIG. 1, or one inside one outside as in FIG. 12, or both outside), and by using the quick-connect stubs with an offset (18), as shown in FIG. 16.

As has been discussed above, the location of the mower on the slope is adjusted by driving the tractor on the flat surface closer or farther to the slope. However the width of the flat surface may be limited by either obstacles or safety concerns (for example, driving the tractor in the middle of a public road is undesirable). This problem can be solved by making the articulated part of the connection frame extendable. Then it can be set to a shorter length when mowing at the top of the slope and extended when mowing farther down the slope. Also, the shorter connection frame makes the mower easier to maneuver than the longer one.

One possible way to achieve the extendability is by assembling the articulated part of the connection frame from multiple sections connected by the same quick connection method as discussed before and shown in FIG. 14. For example, if two frame sections are provided of length 4 ft and one of length 2 ft, that would allow to assemble the frames of any length between 4 ft and 10 ft with the step of 2 ft. If the mower end of the articulated part of the frame includes a bend as shown in FIG. 8, the bend can be incorporated in a distinct separate end section.

Another possible way is by making the rails of the frame telescoping, with the extended sections sliding out or over of the base sections. The extended sections cannot use the full X-bracing, due to the packaging requirements of the telescoping they are limited to one perpendicular beam near the end. However if they slide over the base sections, they may also have the fully-stressed skin and possibly an X-shaped thickening on the skin.

Yet another way is to use the folded frame that can be unfolded and snapped into the straight position, and more ways of extension can be devised.

An important concern for operation of the mower (2) is the possibility of overturning it by the lateral forces from inexpert driving. One way to reduce the side forces by the better location of the mount points has been described above and shown in FIG. 8.

As also can be seen from FIG. 5, FIG. 6 and FIG. 8, if the mower starts overturning in the direction away from the tractor, its body (2) or wheels will hit the articulated part of the connection frame (4) and stop, thus preventing the overturning. If the spacing between the mower body and the connection frame is too wide, the additional bump stops may be fitter on either of them. In case if the mower starts overturning in the direction towards the tractor, the same safety measure may be provided by extending the articulated part of the connection frame (4) past the mower mount points (20), as shown in FIG. 21. If the frame includes a bend for clearance as show in FIG. 8, the extension will acquire the gull-wing shape. In case if the connection frame is mounted to the mower through the quick-connect stubs, the extension may be a part of the stubs rather than the part of the frame.

However the simple-minded connection frame extension as shown in FIG. 21 would prevent the operation of the mower in a ditch, as shown in FIG. 7. To avoid this, the extensions can be made removable through a quick-connect method, and/or their angle can be made adjustable.

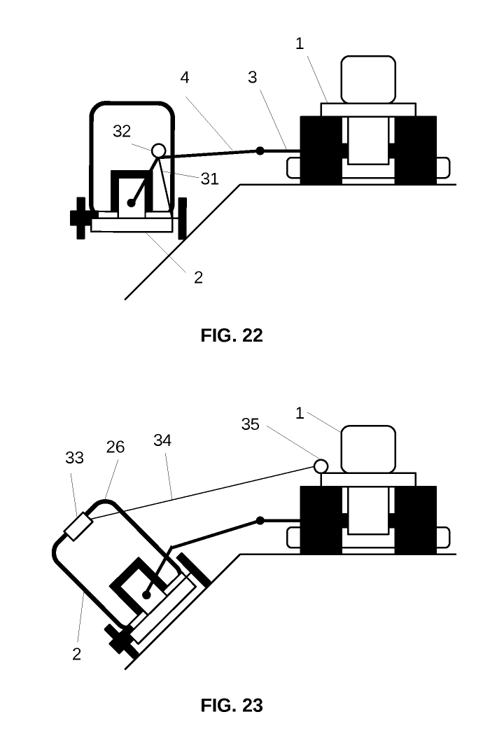

Another way to prevent the overturning of the mower towards the tractor is by using a tether, as shown in FIG. 22. The mower body (2) is connected to the articulated part of the connection frame (4) with a tether (31). Since the slack of the tether must not be allowed to interfere with the mower blade, the spring-loaded spool (32) is used to take up the slack. The spool may be mounted on the connection frame as shown or on the mower body. Depending on whether the mowing is done down-slope as in FIG. 5 or up-slope as in FIG. 6 or in a ditch as in FIG. 7, the limit on the length of the tether must be adjusted appropriately.

Another method to reduce the possibility of overturning the mower is to make the wheels of the mower slippery in the lateral direction. Then the lateral forces will be more likely to make the mower slip rather than overturn it. The location of the mower on the slope is guaranteed by the tractor it is connected to, and there is no need for the wheels' resistance to the slippage. Typically the mowers are produced with the wheels that resist the lateral movement, with the rubber tires of square profile with deep tread. Making them slippery requires the opposite: tires of rounded profile made of smooth slippery plastic with no tread or tread directed only across the tire. Such tires or whole wheels can be retrofitted to the existing mowers.

If no retrofit is available, the mower wheels can be made more slippery by wrapping their tread with a slippery material, such as the HVAC aluminized tape, or a slippery plastic tape specially produced for this purpose.

The slippery mower wheels have demonstrated themselves to be more convenient than the rubberized ones even for the manual operation of the mower. The axles of the wheels are rarely straight, so on the flat terrain the mower tends to pull sideways and require a force from the operator to keep the path straight. The slippery wheels reduce this force while still providing the general direction. When mowing the steeply sloped areas manually, the rubberized wheels do not have enough grip to keep the mower straight in any case, the mower hangs at an angle and has to be dragged with a force applied at an angle. The slippery wheels reduce the dragging force and make the operation easier.

The straightforward solution to the further reduction of the side resistance is to use the caster wheels. However the caster wheels are difficult to fit, because to allow for the caster effect they require the clearance on all sides larger than the radius of the wheel. Only the relatively small caster wheels can be fit without mounting them on the long outriggers. The mowed terrain is often bumpy, the small wheels can easily become stuck on the bumps. Because of this the mowers have wheels of a large radius. The problems of both approaches can be alleviated by using both the smaller caster wheels (22) and the larger main wheels (21), as shown in FIG. 18. The caster wheels are adjusted to reach slightly lower than the main wheels, allowing to for the easy lateral movement on the smoother terrain most of the time, while the larger main wheels help to drive over the bumps and pits where the small caster wheels would become stuck otherwise. Four caster wheels can be used on all corners of the mower as shown in FIG. 18, or only two caster wheels can be used on one half (front or rear) of the mower. When using the mower manually, the most convenient configuration is with only two casters on the front of the mower, in the configuration similar to a common shopping cart.

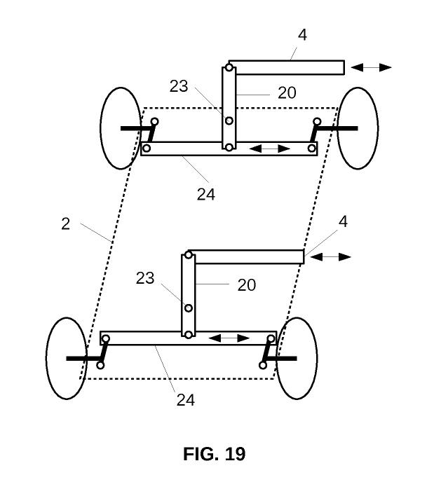

If the mower is designed from the start to be used together with the tractor, its control can be improved by the use of the automatic active steering on the main wheels instead of using the casters. The steering can be controlled by the force that the connection frame applies to the mounts on the mower: if the mower is pulled by the frame towards the tractor, move the wheels to steer towards the tractor; if the mower is pushed by the frame away from the tractor, move the wheels to steer away from the tractor. The steering control of the front and the rear wheels is symmetrical. When the mower is used manually without the tractor, the steering would be locked in the center position. The diagram of the automatic steering mechanism is shown in FIG. 19. The body of the mower (2) is shown as an outline. The ends of the articulated parts of the connection frame (4) transfer the forces by the horizontal movement relatively to the mower. The mounts (20) on the mower are connected through an axle to the mower body at the pivot point (23) and to the steering parallelogram control rod (24) at the bottom. Thus the movement of the connection frame relative to the mower translates to the movement of the steering parallelogram and steers the wheels.

Since the mower's safety lever (which stops the mower engine unless the lever is held in the operating position by the operator) is defeated by clamping for operation with the tractor, additional safety measures may be added by releasing the clamp on the safety lever if overturned. If the mower is designed from the start for the use with the tractor, this safety can be built into the mower instead, by disabling the ignition and/or closing the throttle plate. For a general mower this safety measure can be achieved by a clamp that self-releases when it is angled. Multiple varieties of such a clamp can be devised.

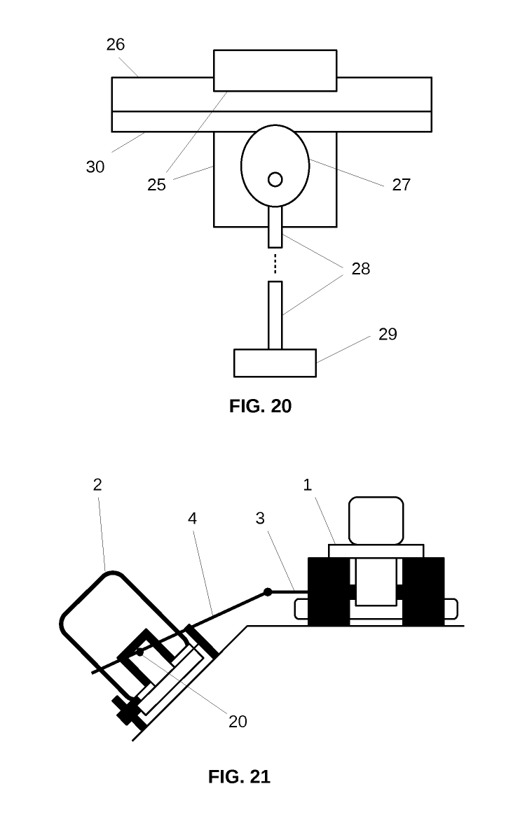

An example of one variety is shown in FIG. 20. The safety lever (30) is typically located below (as shown in the figure) or above the mower handle (26) and is engaged by holding it clamped to the mower handle. The clamp body (25) extends from a hook over the mower handle (26) to below the safety lever (30). The clamp body may be bolted to the mower handle, and its dimensions can be made adjustable to accommodate various mower models. On the underside of the clamp body (25) the cam (27) is mounted to it through an axle. The cam has a long lever (28) rigidly attached to it, with the weight (29) on the end of the lever. When the mower is horizontal and the cam lever (28) is vertical, the cam (27) clamps the mower safety lever (30) to the mower handle (26) and enables the mower's engine operation. When the mower leans sideways, the weight (29) acts on the cam lever (28) to keep it vertical, thus turning the cam relatively to the mower handle (26). A large enough angle turns the cam into the position where it no longer clamps the safety lever (30), releasing it and stopping the engine. The profile of the cam can be chosen to allow a certain angle before the release. The weight of the cam weight (29) and its position on the cam lever (28) can also be used to adjust the angle at which its force overcomes the friction and moves the cam.

The same principle of the weight on a lever or an analogous acceleration-sensing electronic device may be used to control the ignition circuit of the mower.

Yet another method to stop the mower safely in case of overturning is by allowing the operator to stop the mower engine remotely, without dismounting from the tractor. This can be achieved by a safety clamp that is held by a pin, with a cable attached to the pin and the other end of the cable brought into the location conveniently reachable by the operator. In case of an emergency the operator would pull on the cable, which will pull out the pin, causing the clamp to release its grip on the safety lever and stop the mower engine. This is shown in FIG. 23 where the remotely releasable clamp (33) is mounted on the handle (26) of the mower (2), holding its safety lever. The control cable (34) is connected to the clamp's (33) release pin on one side and to a spring-loaded spool (35) that takes up the cable slack on the other side. The spool (35) is in turn mounted on the tractor (1). Many variations of this method are possible, such as by using an electrical connection instead of a mechanical cable, and/or by controlling the mower's engine directly rather than through the clamp and safety lever.

A common self-propelled mower cannot be used connected to the tractor, since its movement would be impossible to control and coordinate with the tractor. The mower can normally only be used in a passive mode, without its own drive engaged. However a low-powered motor that is not enough to propel the mower by itself but can only help the tractor propel it can be beneficial for maneuverability, especially with the long connection frames. This motor and/or its transmission should be flexible enough to follow the speed set by the tractor, and provide little resistance when the motor is turned off. A low-powered electric motor, with a separate motor for each wheel, fits this requirement. The common electric generators of the lawn tractors are able to produce the small amounts of power needed for such motors. A rectifier plugged into the tractor's electrical system can be used to power such motors. The simple control of forward, off, reverse modes is done with one switch that reverses the polarity of the electric current. This switch can be integrated into the tractor's transmission selector, automatically selecting the same direction as for the tractor, with the possibility of the manual override switch for the situations when the tractor and the mower move in the opposite directions rotating around a common center.

If the mower uses the caster wheels, they cannot be used on the same half (front or rear) as the electric motors. This configuration may use two caster wheels on one half (possibly along with the non-driven main wheels) and two driven main wheels on another half.

1. The slope mowing apparatus comprising a tractor, a powered walk-behind mower, the mounts on the walk-behind mower, and a connection frame;
the definition of the tractor here is not limited to the proper tractors but includes all the sub-types of the riding mowers;
whereby the connection frame is mounted across between the tractor and the walk-behind mower, connecting them substantially side-by-side, substantially parallel to each other and separated by the length of the connection frame;
whereby the connection frame comprising two joined parts: the fixed part that is fixed rigidly to the tractor with no more flexibility than to accommodate the normal flex of the tractor's frame, and the articulated part that connects the end of the fixed part farthest from the tractor to the mounts on the walk-behind mower, the connections on both ends of the articulated part allowing the free articulation around the axles that are substantially longitudinal relatively to the whole apparatus;
whereby the size and shape of the fixed part of the connection frame is selected to provide the articulated part of the connection frame with the sufficient clearance to prevent its contact to the parts of the tractor and to the ground during the normal operation;
whereby the length of the articulated part of the connection frame is selected to provide the placement of the mower on the slope while the tractor is driven on the flat terrain next to the slope;
whereby both parts of the connection frame are substantially rigid against the forces in the horizontal plane;
whereby the fixed part of the connection frame and its mounting to the tractor are also substantially rigid against the forces in the pitch and roll directions;
whereby the articulating joints between the two parts of the connection frame, and between the articulated part of the connection frame and the mounts on the walk-behind mower allow the rotation around the substantially longitudinal axles and provide sufficient rigidity in the horizontal plane;
whereby the mounts on the mower are substantially rigidly connected to the mower, the rigidity of the mounts and of the articulated joints in the horizontal plane substantially disallowing the rotation of the mower relative to the tractor in the yaw direction, locating the body of the mower substantially parallel to the tractor, thus allowing the whole apparatus to mow both forwards and in reverse and to perform turns while mowing without substantially changing this relative location;
whereby the height of the mounts on the walk-behind mower provides the articulated part of the connection frame with the sufficient clearance to prevent its contact to the parts of the mower and to the ground during the normal operation.

2. The walk-behind mower that provides the compact outer dimensions, high maneuverability, and high cross-terrain ability;
comprising the four traditional fixed main wheels and two or four additional caster wheels;
whereby the caster wheels are mounted to the bottom of the body of the mower in pairs either in front or behind or both in front and behind the mower, wheels in a pair mounted sufficiently wide on the body to provide the lateral stability of the mower while avoiding interference with the other parts of the mower;
whereby the caster wheels are protruding by a small distance below the level of the main wheels on the same (front or rear) side of the mower, such that on the flat ground the said side of the mower rides only on the caster wheels while the main wheels of this side come into the contact with the ground only on the uneven ground.

3. The walk-behind mower with increased resistance to overturning and easier straight-line tracking;
whereby the wheels of the mower are made more slippery in the lateral direction by the use of at least one of: the wheel shape with the rounded shoulders, the tread that is smooth or contains only the straight cross-bars, the tread surface made of a low-friction material.

4. The apparatus of claim 1 wherein:
the fixed part of the connection frame has a flat shape;
whereby the clearance between the articulated part of the frame and the tractor parts and the ground is achieved by extending the fixed part of the connection frame horizontally, its end sufficiently far away from the tractor's frame.

5. The apparatus of claim 1 wherein:
the fixed part of the connection frame has a shape with the end farthest from the tractor bent upwards, reminiscent of the letter L when viewed from behind the tractor;
whereby the clearance between the articulated part of the frame and the tractor parts and the ground is achieved in part by extending the fixed part of the connection frame vertically, its far end sufficiently high above the interference, thus allowing to reduce the horizontal distance between the said end and the tractor.

6. The apparatus of claim 1 wherein:
the suitably strong tractor's frame also acts as the fixed part of the connection frame.

7. The apparatus of claim 1 wherein:
the fixed part of the connection frame is built in a three-dimensional shape commonly known as a space-frame.

8. The apparatus of claim 1 wherein:
the fixed part of the connection frame is mounted near the center of the tractor.

9. The apparatus of claim 1 wherein:
the fixed part of the connection frame is mounted near the rear wheels of the tractor.

10. The apparatus of claim 1 wherein:
the articulated part of the connection frame is shaped with a bend downwards, the said bend allowing to use the shorter mounts on the walk-behind mower while preserving the required clearances.

11. The apparatus of claim 1 wherein:
some of the connection frame parts or the mounts on the walk-behind mower provide the quick disconnection from the other parts;
whereby the disconnection is done by the means of stubs, the stubs defined here as the short sections similar in cross-section to the ends of the corresponding part, that can be slid snugly either over or into the part's end, and fixed by passing a bolt or pin through a hole across both the stub and the end, and further fixing the bolt or pin by a nut or retaining pin;
whereby instead of joining the end of a part to another part, the stub of the first part is joined to another part, thus allowing the quick disconnect between the first part and its stubs that remain joined to another part.

12. The apparatus of claim 1 wherein:
the width of the connection frame is made adjustable to accommodate the dimensions of the various models of the tractors and walk-behind mowers;
whereby the adjustability is achieved through the selection of the elements from a set during the assembly of the connection frame;
the said selective elements being at least one of: the holes or indentations or other marks on the components of the frame or the stubs of the components of the frame;
whereby the components are defined here as the pre-manufactured elements that are assembled together to build the fixed part and the articulated part of the connection frame;
whereby the set of holes or indentations or other marks allows to assemble together the components of the frame in the varying positions, using one of the holes or indentations or other marks in the set to connect two components at it;
whereby a stub is defined here as a short section that gets fixed to the end of the corresponding component, the stub then connecting to another component instead of connecting the said components directly to each other, or in a sub-type of the stubs known as the inserts both the insert and its corresponding component connect to another component, the insert effectively widening the end of the corresponding component and thus replacing the otherwise empty space and removing the free-play;
whereby the set of stubs includes the stubs that provide the varying offsets between the end of the component and the end of the stub.

13. The apparatus of claim 1 wherein:
the articulated part of the connection frame has an adjustable length;
whereby the articulated part of the connection frame comprises multiple sections, the length adjustment achieved by inserting and removing these sections;
whereby the sections may be inserted by either physically inserting these sections using the quick connections or by telescoping them out of the other sections, and removed by the opposite action.

14. The apparatus of claim 1 wherein:
the walk-behind mower comprises the automatic steering system, the said steering system further comprising:
the front and rear mounts on the walk-behind mower for the articulated part of the connection frame implemented as rods pivoted on the substantially longitudinal axles on the body of the mower, extending below these pivot points;
the lower end of each of said mount rods flexibly joined to the control rod of a steering parallelogram of the front or rear wheels accordingly, whereby the joint between a mount rod and a control rod allows the mount rod to move the control rod transversely while accommodating for the varying angle and distance between them;
each steering parallelogram, sometimes also known as the steering trapeze, formed by the control rod and the steering knuckles, the control rod being mounted across the body of the mower and allowed to move transversely, its ends joined using a rotating joint to the ends of steering knuckles that are mounted to the sides of the mower body pivoting on the substantially vertical axles, with the substantially horizontal wheel axles extending outwards from the knuckles;
whereby the front steering parallelogram is oriented such that the control rod is located at the rear side of the parallelogram, the rear steering parallelogram is oriented such that the control rod is located at the front side of the parallelogram.

15. The apparatus of claim 1 wherein:
the articulated part of the connection frame extends beyond its connection to the mounts on the walk-behind mower;
whereby the said extension is angled suitably to not interfere with the roll of the mower within a safe range of angles during the normal operation but to stop the body of the mower from the further roll before the roll angle becomes unsafe.

16. The apparatus of claim 1 wherein:
the apparatus further comprises a safety tether that is attached between a point on the body of the walk-behind mower and a point on the articulated part of the connection frame;
whereby the length of the tether and location of its endpoints is selected to not interfere with the roll of the mower within a safe range of angles during the normal operation but to stop the body of the mower from the further roll before the roll angle becomes unsafe.

17. The apparatus of claim 1 wherein:
the walk-behind mower comprises a safety system that detects the roll angle of the mower and stops the engine of the mower if the roll angle becomes unsafe.

18. The apparatus of claim 1 wherein:
the apparatus further comprises an external safety device that acts on the control cable of the walk-behind mower's built-in safety system that stops the mower's engine in the absence of the human operator;
whereby the said safety device simulates the presence of the human operator during the normal operation by acting directly or indirectly on the control cable;
whereby the said safety device detects the roll angle of the mower, and if the roll angle becomes unsafe, releases the control cable, the release triggering the mower's built-in safety system and stopping the engine.

19. The apparatus of claim 1 wherein:
the apparatus further comprises a safety system that stops the engine of the walk-behind mower when activated remotely by the operator of the apparatus.

20. The apparatus of claim 1 wherein:
the walk-behind mower comprises an auxiliary drive system that improves the maneuverability of the apparatus;
the auxiliary drive system comprising the electric motors connected to one or more wheels of the mower and the control system;
whereby the control system allows the operator or the automation to select the strength and direction of the force applied by the motors in coordination with the movement of the tractor;
whereby the motors allow the wheels of the mower to rotate freely when not powered.
